(19) United States
(12) Patent Application Publication
(10) Pub. No.: US 2010/0182161 A1
(43) Pub. Date: Jul. 22, 2010

(54) WIRELESS TELEMETRY REPEATER SYSTEMS AND METHODS

(75) Inventors: Carl A. Robbins, Houston, TX (US); Eugene Linyaev, Houston, TX (US); Li Gao, Missouri, MO (US)

Correspondence Address: KRUEGER ISELIN LLP (1391), P O BOX 1906, CYPRESS, TX, 77410-1906, US

(73) Assignee: Halliburton Energy Services, Inc., Houston, TX (US)

(21) Appl. No.: 12/090,105

(22) PCT Filed: Apr. 28, 2007
(86) PCT No.: PCT/US07/10573

§ 371 Date: Mar. 25, 2010

(51) Int. Cl. G01V 3/00

(52) U.S. Cl. 340/853.7

(57) ABSTRACT

Various electromagnetic LWD telemetry systems are disclosed having a wireless repeater positioned on or near the seabed. The wireless repeater receives and demodulates electromagnetic uplink signals and retransmits the uplink signals from the seabed as electromagnetic or acoustic signals. A receiver on the drilling platform or suspended from the water's surface receives the uplink signal and forwards it to a facility for processing and storage. In some embodiments, the wireless repeater takes the form of a sub threaded inline with the drill string with an electromagnetic signal sensor positioned inside the drill string. In other embodiments, the wireless repeater takes the form of a unit that rests on the seabed with electromagnetic signal sensors inserted into the sea bottom.

### BACKGROUND

Modern petroleum drilling and production operations demand a great quantity of information relating to parameters and conditions downhole. Such information typically includes characteristics of the earth formations traversed by the borehole, along with data relating to the size and configuration of the borehole itself. The collection of information relating to conditions downhole is referred to as “logging.”

Logging frequently is done during the drilling process, eliminating the necessity of removing or “tripping” the drilling assembly to insert a wireline logging tool to collect the data. Data collection during drilling also allows the driller to make accurate modifications or corrections as needed to steer the well or optimize performance while minimizing down time. Designs for measuring conditions downhole including the movement and location of the drilling assembly contemporaneously with the drilling of the well have come to be known as “measurement-while-drilling” techniques, or “MWD”. Similar techniques, concentrating more on the measurement of formation parameters, commonly have been referred to as “logging while drilling” techniques, or “LWD”. While distinctions between MWD and LWD may exist, the terms MWD and LWD often are used interchangeably. For the purposes of this disclosure, the term LWD will be used with the understanding that this term encompasses both the collection of formation parameters and the collection of information relating to the movement and position of the drilling assembly.

In LWD systems, sensors are located at or near the lower end of the drill string to measure the desired drilling parameters and formation characteristics. While drilling is in progress these sensors continuously or intermittently transmit the information to a surface detector by some form of telemetry. There are a number of existing telemetry systems that seek to transmit information to the surface without requiring the use of an electrical cable. These include mud pulse telemetry systems, acoustic telemetry systems, and electromagnetic wave telemetry systems.

Mud pulse telemetry systems employ a variable constriction to create pressure pulses in the drilling fluid that is circulated through the drill string during drilling operations. Telemetry information is transmitted by adjusting the timing or frequency of these pressure pulses. The information is received and decoded by a pressure transducer and computer at the surface.

Acoustic telemetry systems transmit data using vibrations in the tubing wall of the drill string. The vibrations are generated by an acoustic transmitter mounted on the drill string and propagate along the drill string to an acoustic receiver also mounted on the drill string.

Electromagnetic wave telemetry systems transmit data using current flows induced in the drill string. The current flows are induced by driving a voltage across an insulated gap or a toroidal coil positioned along the drill string. Though some dissipation occurs, the current flows propagate preferentially along the drill string and induce detectable electromagnetic fields in the vicinity of the borehole. Telemetry receivers employ a toroidal coil, an electrical antenna, or a magnetic field sensor to measure the current flow in the drill string or the electromagnetic field near the well head.

Such telemetry systems may encounter technical obstacles when being employed in a deep water drilling environment. In such an environment, the well includes a riser pipe extending from the sea floor to the floating platform. This portion of the well has significantly more dissipative electrical properties than the rest of the well. Accordingly, there has been proposed a telemetry system that employs an insulated electrical cable to overcome the issues associated with communicating through sea water. See, e.g., U.S. Pat. No. 6,144,316, entitled “Electromagnetic and Acoustic Repeater and Method for use of same” and issued on Nov. 7, 2000. However, the electrical cable itself may create operational difficulties and hazards, including entanglement with retaining cables for the platform and navigational hazards for service craft.

### BRIEF DESCRIPTION OF THE DRAWINGS

In the following detailed description, reference is made to the accompanying drawings in which:

FIG. 1 is an environmental view of an off-shore oil well in which a wireless telemetry repeater system, constructed in accordance with at least some embodiments, may be employed;

FIG. 2 illustrates an in-line wireless telemetry repeater system, constructed in accordance with at least some embodiments; and

FIG. 3 illustrates a seabed wireless telemetry repeater system, constructed in accordance with at least some embodiments.

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

The term “uplink” refers to telemetry signals generally directed towards the surface, e.g., from a near-bit transmitter to a repeater, or from a repeater to a surface receiver. Conversely, the term “downlink” refers to signals generally directed towards the bit-end of the drill string, e.g., from a surface transmitter to a repeater, or from a repeater to a near-bit receiver.

### DETAILED DESCRIPTION

Various systems and methods are described for implementing and operating telemetry systems that overcome the seabed riser obstacles without an insulated cable. Some system embodiments include a wireless inline or seabed sensor to detect electromagnetic uplink signals before these signals are dissipated in the seawater. The uplink signals may be demodulated and retransmitted as acoustic or electromagnetic signals to the surface. In addition to boosting the signal strength, these systems enable the use of signaling frequencies most suitable for propagation along the borehole or through the ocean, as needed.

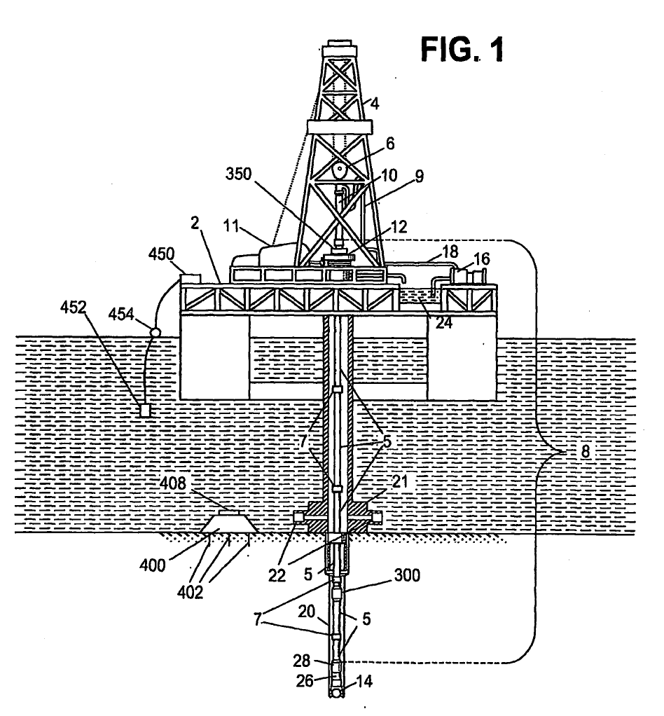

FIG. 1 shows an offshore rig during drilling operations in accordance with at least some illustrative embodiments. A drilling platform 2 is equipped with a derrick 4 that supports a hoist 6. Drilling of oil and gas wells is carried out by a string of drill pipes 5 connected together by “tool” joints 7 so as to form a drill string 8. (In some instances, the drill string 8 may consist of continuous tubing having welded connections between tubing lengths.) The hoist 6 suspends a kelly 10 that is used to lower the drill string 8. A rotary table 12 or a top drive motor may be used to rotate the drill string 8, thereby rotating a drill bit 14 connected to the lower end of the drill string. Drilling fluid is pumped by recirculation equipment 16 through supply pipe 18, through drilling kelly 10, and down through the drill string 8 at high pressures and volumes to emerge through nozzles or jets in the drill bit 14. The drilling fluid then travels back up the hole via the annulus formed between the exterior of the drill string 8 and the borehole wall 20, through wellhead 21 (which includes blowout preventers 22), and into a mud pit 24 within the rig. On the surface, the drilling fluid is cleaned and then recirculated by recirculation equipment 16. The drilling fluid serves to cool the drill bit 14, to carry cuttings from the base of the bore to the surface, and to balance the hydrostatic pressure in the rock formations.

Sensors within downhole tool 26 are coupled to downhole transmitter 28, which transmits telemetry (i.e., information-carrying signals) along drill string 8. Telemetry may be transmitted electromagnetically, though acoustic telemetry is also contemplated. Telemetry transmissions from downhole transmitter 28 may include data sent as it is collected (“continuous” or “real-time” data), data stored and transmitted after a delay (“buffered” or “historical” data), or a combination of both, each transmitted at different times during drilling operations. Logging while drilling (LWD) data collected during actual drilling may be collected at a relatively high resolution and saved locally in memory (e.g., within downhole tool 26 or downhole transmitter 28). This high-resolution data may be needed in order to perform a thorough analysis of the downhole formations. But because of the limited bandwidth of downhole telemetry systems, real-time data may have to be transmitted at a much lower resolution. In at least some embodiments the data may be saved at a higher resolution as described above, and transmitted to the surface at a later time when the tool is still downhole, but while drilling is not taking place (e.g., when a tool gets stuck or when the hole is being conditioned). This historical data transmission may be at a sample resolution higher than the resolution normally used for real-time data transmission.

The downhole tool 26 and downhole transmitter 28 may be adapted to receive commands transmitted from the surface. These commands may, for example, control the suspension of real-time data collection and/or transmission, the selection of saved data, the selection of the desired resolution of data transmission, the initiation of saved data transmission, the suspension of saved data transmission, and the resumption of real-time data collection and/or transmission.

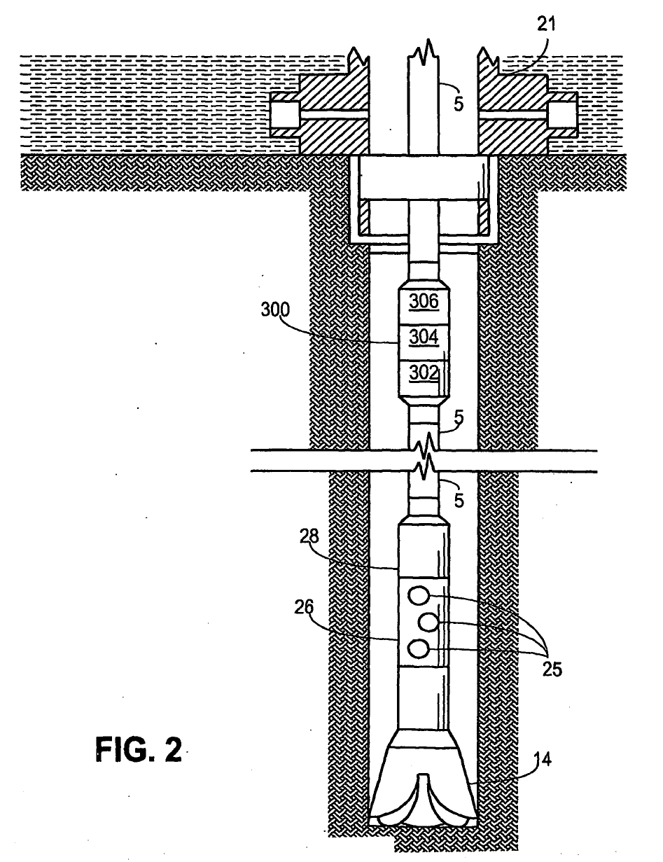

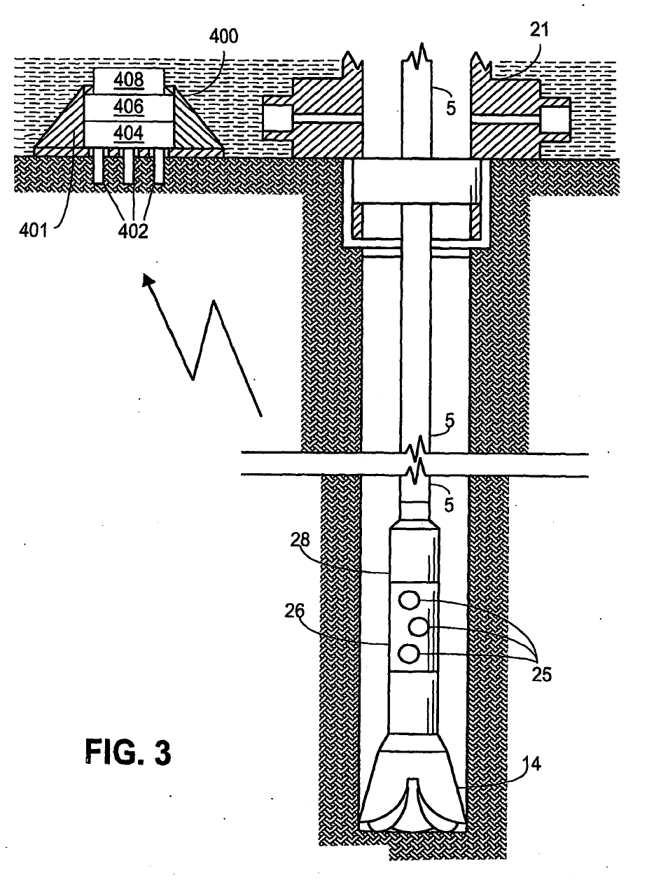

The telemetry system of FIG. 1 includes either a wireless inline repeater 300 (FIG. 2) or a wireless seabed repeater 400 (FIG. 3) to receive uplink telemetry signals at or near the transition between the ocean water and the underlying formations and to convert the uplink signals to a form more suitable for propagation through the ocean. The repeaters may be bi-directional, i.e., configured to also receive downlink signals to convert into a form more suitable for propagation through the earth.

FIG. 2 shows a telemetry system having a wireless inline telemetry repeater. Data is collected by downhole tool 26 based on measurements taken using sensors 25 and may be immediately transmitted or saved for later transmission. Downhole transmitter 28 modulates the data on a telemetry signal that is driven through a toroidal coil or across an insulating gap to induce a corresponding current flow along the drill string 8. The current dissipates from the drill string 8 into the surrounding formations, transforming into an electromagnetic signal that propagates preferentially along the drill string.

An electromagnetic receiver 302 detects and demodulates the electromagnetic signal into uplink data. As part of the demodulation operation, the receiver 302 may perform amplification, filtering, analog-to-digital conversion, buffering, and error correction. A controller 304 passes the uplink data to a transmitter 306 that modulates the uplink data onto a new signal and transmits it to the surface. The new signal may be an electromagnetic signal having a different carrier frequency or a broadband modulation scheme. As an alternative, the new signal may be an acoustic signal that is transmitted along drill string 8. In this alternative, transmitter 306 includes an acoustic transducer to generate modulated acoustic vibrations on the drill string, such as a stack of piezoelectric washers sandwiched between flanges on drill string.

In some embodiments, the inline telemetry repeater also receives and retransmits a downlink signal. The downlink signal can be handled in the same fashion as the uplink signal. To prevent interference between the uplink and downlink signals, frequency division multiplexing, code division multiplexing, or half-duplex signaling may be used. Any suitable signal modulation technique may be employed, including phase shift keying (PSK), frequency shift keying (FSK), quadrature amplitude modulation (QAM), and discrete multi-tone (DMT) modulation. The inline repeater includes a power source such as a battery. In some embodiments, the inline repeater includes a electrical generator powered by the flow of drilling fluid.

At the surface, an electromagnetic uplink signal can be detected with an antenna or magnetometer coupled to the drill string or located in the vicinity of the drill string. Similarly, accelerometers or other acoustic sensors coupled to the drill string can be used to receive an acoustic uplink signal. The uplink signal is demodulated and the telemetry data provided to a surface facility for processing and storage.

It is important to note that electrical conditions above and below wellhead 21 may vary significantly. Below the wellhead, the well casing is surrounded by cement and/or earth formations that generally have a higher resistivity than seawater. For this reason, electromagnetic waves propagating along the well bore typically suffer less dissipation below the wellhead than above the wellhead. Because of the rapid attenuation of the uplink signal above the wellhead, the strength and fidelity of the uplink signal received at the sea surface depend very much on the placement of the repeater 300. In at least some embodiments, telemetry repeater 300 is positioned at or near the wellhead. With this placement, the repeater is able to receive the uplink signal before the signal suffers excessive attenuation by the ocean while being well-placed to transmit through the highly-attenuating region to the surface. Moreover, the transmit characteristics of the repeater can be optimized for propagation through seawater without impairing the operation of the downhole transmitter. Optimization may include the selection of modulation modes and carrier frequencies that are less prone to attenuation, phase shift, and/or distortion than other modes and frequencies for a given region (above or below the wellhead).

In order to maintain optimal positioning, telemetry repeater 300 is periodically repositioned as drilling progresses. In at least some illustrative embodiments, repositioning of telemetry repeater 300 is preformed whenever the drill string is removed from the well to change out drilling bits. Thus, for example, if the drilling bit is replaced once after every 1,000 feet drilled, telemetry repeater 300 will also be repositioned at that same interval. As a result, acoustic telemetry repeater 300 will never be more than 1,000 feet below the wellhead in the example described.

The receiver 302 may take the form of a sub that threads into place between two joints of drill pipe. The receiver may employ an insulating gap or a toroid to detect current flow in the drill string. As an alternative, the receiver may employ a magnetic field detector to detect the electromagnetic signal. In some embodiments, the magnetic field detector is positioned inside the drill string. To enable magnetic field detection, a portion of the drill string wall may consist of an insulating or resistive material designed to concentrate current flow into a relatively narrow region of the drill string circumference.

FIG. 3 shows a telemetry system having a wireless seabed telemetry repeater 400 located near the wellhead 21. As downhole transmitter 28 transmits an electromagnetic uplink signal, the signal is detected by electromagnetic sensors 402. The electromagnetic sensors 402 may extend into the seabed from repeater housing 401, which is weighted down to prevent movement of the repeater. The housing 401 may include any number of dense materials such as stone or cement. Further, an automated release mechanism may allow for commanded or automated release of the repeater instrumentation, which may be housed in a buoyant package that carries the instrumentation to the surface for recovery.

Sensors 402 may take the form of electrodes or antennas that measure electrical fields, or magnetometers that measure magnetic fields. The antennas or magnetometers may include multiple, orthogonally oriented dipole sensors. Each of these sensors may be used alone or in combination with each other. Sensors 402 convert the electromagnetic signals to electrical signals. A receiver 404 demodulates the electrical signal to obtain the uplink data. As part of the demodulation operation, receiver 404 may perform amplification, filtering, analog-to-digital conversion, buffering, and error correction. A controller 406 passes the uplink data to a transmitter 408 that modulates the uplink data onto a new uplink signal and transmits it to the surface. As before, the new signal may be an electromagnetic signal having a different carrier frequency or a broadband modulation scheme. In an alternative embodiment, the new signal is a low-frequency acoustic signal designed to propagate through the seawater. In some embodiments, the seabed repeater 404 also receives and retransmits downlink signals. The wireless seabed telemetry repeater includes a power source such as a battery.

Referring back to FIG. 1, the uplink signal from seabed repeater 404 is received at or near the water's surface by a sensor 452, which may be suspended from the surface of the water by retrievable cable and buoy 454 coupled to a retrieval system 450. Because the cable and buoy are retrievable, they can easily be recovered or repositioned to avoid creating a navigational hazard. Multiple sensors may be deployed along the length of the cable and/or multiple such cables may be deployed to enable array processing, thereby increasing sensitivity to the uplink signals and decreasing sensitivity to electrical or acoustic noise emanating from the platform. Signal triangulation may be employed to determine the exact position of the repeater on the seabed. In some system embodiments, multiple seabed receivers may be employed to enable array processing and triangulation based on signals from the downhole source. A low-frequency signal beacon located somewhere in the system may transmit a synchronization signal to each of the seabed repeaters. Such synchronization is helpful for associating signal measurements with a system-wide time reference, so that the signal measurements can be later combined (e.g., at the surface) to perform array processing and/or triangulation.

The disclosed system embodiments may avoid numerous issues associated with a cabled repeater embodiment. Cables may move due to current, wave action, or boat traffic, causing the sensor to move. Such motion may introduce errors into the telemetry signals, particularly low frequency magnetic fields suffering interference from relatively strong earth magnetic fields. High-strength cables are often difficult to deploy, and they suffer from limitations on cable lengths, limiting the water depth in which they can be employed. Permanent cables may present obstructions to boat traffic, and they may provide a noise path from the rig to the sensor. Each of these issues can be avoided using wireless sensors. Moreover, the wireless system may have certain benefits in terms of ease of deployment and reduced noise due to isolated placement.

The above disclosure is meant to be illustrative of the principles and various embodiments of the present invention. Numerous variations and modifications will become apparent to those skilled in the art once the above disclosure is fully appreciated. For example, although the embodiments of both the inline and the seabed repeaters are shown and described as transmitting downhole data to the surface, other illustrative embodiments may include additional receivers and transmitters configured to receive data and/or commands from equipment at the surface and retransmit the data/commands to the downhole instruments. Also, although the embodiments described and shown illustrate systems in which the downhole transmitter and the surface receiver both communicate directly with the wireless telemetry repeater, other embodiments may include intervening repeaters placed along the length of the drill string. It is intended that the following claims be interpreted to embrace all such variations and modifications.

What is claimed is:

1. A wireless telemetry repeater that comprises:
an electromagnetic signal receiver that receives and demodulates an electromagnetic uplink signal to obtain uplink data; and
an acoustic transmitter that retransmits the uplink data as an acoustic uplink signal.

2. The repeater of claim 1, wherein the telemetry repeater is an inline repeater.

3. The repeater of claim 2, wherein the inline repeater is positioned near the seabed during the drilling process.

4. The repeater of claim 1, wherein the telemetry repeater is a seabed repeater.

5. The repeater of claim 1, wherein the electromagnetic signal receiver includes at least one of an antenna, a magnetometer, and a toroid.

6. The repeater of claim 1, further comprising:
an acoustic receiver that receives and demodulates an acoustic downlink signal to obtain downlink data; and
an electromagnetic transmitter that retransmits the downlink data as an electromagnetic downlink signal.

7. The repeater of claim 6, wherein the uplink and downlink acoustic signals are frequency multiplexed.

8. The repeater of claim 6, wherein the uplink and downlink electromagnetic signals are code division multiplexed.

9. A wireless telemetry repeater that comprises:
an electromagnetic signal receiver that receives and demodulates a first electromagnetic uplink signal to obtain uplink data from a downhole transmitter; and
an electromagnetic signal transmitter that retransmits the uplink data as a second electromagnetic uplink signal that propagates through seawater.

10. The repeater of claim 9, wherein the transmitter is an inline transmitter that is positioned near the seabed during the drilling process.

11. The repeater of claim 9, wherein the transmitter transmits the second electromagnetic signal by generating a current flow in a drill string.

12. The repeater of claim 9, wherein the transmitter is a seabed repeater.

13. The repeater of claim 9, wherein the second electromagnetic uplink signal is sent in a frequency band below the frequency band of the first electromagnetic uplink signal.

14. The repeater of claim 9, wherein the electromagnetic signal receiver further receives a first electromagnetic downlink signal, and the electromagnetic signal transmitter retransmits downlink data as a second electromagnetic downlink signal.

15. The repeater of claim 9, wherein the electromagnetic signal receiver includes a magnetometer positioned inside a drill string.

16. A wireless telemetry method that comprises:
receiving an electromagnetic uplink signal from a downhole transmitter during drilling operations;
demodulating the electromagnetic uplink signal to obtain uplink data; and
retransmitting a second uplink signal to transport the uplink data wirelessly through water.

17. The method of claim 16, further comprising:
receiving a first downlink signal wirelessly through water;
demodulating the downlink signal to obtain downlink data; and
transmitting an electromagnetic downlink signal to convey the downlink data to a downhole receiver during drilling operations.

18. The method of claim 17, wherein the first downlink signal and the second uplink signal are acoustic signals.

19. The method of claim 17, wherein the first downlink signal and the second uplink signal are electromagnetic signals.

20. The method of claim 16, wherein said receiving, demodulating, and retransmitting is preformed by a seabed receiver.
